(19) United States
(12) Patent Application Publication
(10) Pub. No.: US 2026/0099395 A1
(43) Pub. Date: Apr. 9, 2026

(54) PREDICTING PIPE FAILURE

(71) Applicant: Fracta, Mountain View, CA (US)

(72) Inventors: Alex GOMORY, Rancho Cucamonga, CA (US); Chase ROWE, Palo Alto, CA (US); Ted Sindabizera NTWARI, Redwood City, CA (US); Ashlyn JEW, San Francisco, CA (US); Noel VINCENT, Kyoto-shi (JP); Takeshi NOMURA, Tokyo (JP); Masaaki IHARA, Osaka-shi (JP)

(21) Appl. No.: 19/347,572

(22) Filed: Oct. 1, 2025

Related U.S. Application Data
(60) Provisional application No. 63/703,587, filed on Oct. 4, 2024.
(60) Provisional application No. 63/703,685, filed on Oct. 4, 2024.

(51) Int. Cl. G06F 11/00; F17D 5/02

(52) U.S. Cl. CPC G06F 11/004; F17D 5/02; G06F 2201/81

(57) ABSTRACT

An apparatus predicts a failure occurring in a pipe network, the apparatus comprising a reading module configured to read connection data, wherein the connection data comprises data indicating pipe segments and data valves, and wherein an end of each pipe segment is connected to an end of another pipe segment or a valve, a clustering module configured to automatically create data indicating clusters from the connection data, wherein each cluster comprises some of the at pipe segments which form a connection network between some of the valves, a cluster likelihood of failure (LOF) calculating module configured to calculate an LOF of each cluster by summing LOFs of the pipe segments included in the cluster, and a displaying module configured to display the data indicating the clusters and the LOF of each cluster on a display device.

This patent application claims the benefit of and incorporates by reference each of the following provisional applications: U.S. Prov. Ser. No. 63/703,587 filed Oct. 4, 2024; and U.S. Prov. Ser. No. 63/703,685 filed Oct. 4, 2024

### TECHNICAL FIELD

The present disclosure relates to apparatuses, methods, and programs for predicting a pipe failure.

### BACKGROUND

There is a strong need for a method and system for predicting the probability of underground pipe failure with high accuracy. The pipe segment degradation diagnostic technology using AI and environmental big data allows the risk of future degradation to be determined with high accuracy without directly checking the pipe body after excavation, by using environmental data under the ground related to physical and chemical degradation of the pipe, pipeline information and water leakage information. The risk of future degradation is provided on the user screen, and the risk assessment also becomes possible.

However, in the conventional technology, the likelihood of leakage (failure) is calculated for each underground pipe having the end portions as joints, and thus it is not always easy to determine the influence of leakage.

### SUMMARY

The present disclosure provides a technology for clustering one or more underground pipes and predicting a leakage risk in each cluster.

A first aspect of this disclosure provides an apparatus for predicting a failure occurring in an underground pipe network. The apparatus comprises a reading module, a clustering module, a cluster likelihood of failure (LOF) calculating module, and a displaying module. The reading module is configured to read connection data, wherein the connection data comprises data indicating at least one pipe segment and data indicating at least one valve, and wherein an end of each pipe segment is connected to an end of another pipe segment or a valve. The clustering module is configured to automatically create data indicating at least one cluster from the connection data, wherein each cluster comprises one or more of the at least one pipe segment which form a connection network between one or more of the at least one valve. The cluster LOF calculating module is configured to calculate an LOF of each cluster by summing LOFs of the pipe segments included in the cluster. The displaying module is configured to display the data indicating the at least one cluster and the LOF of each cluster on a display device.

With this apparatus, the LOF per cluster partitioned by valves can be displayed. Accordingly, a more practical unit of failure impact can be understood, and repair plans in units of clusters partitioned by valves can be formed more easily.

The reading module may further be configured to read population prediction data per area, and the displaying module may be further configured to display the population prediction data in addition to the data indicating the at least one cluster and the LOF of each cluster. Then, it becomes possible to visualize the LOF together with the population that is predicted to be affected if the failure occurs in the future.

The apparatus may further comprise an individual LOF calculating module configured to calculate an LOF of the pipe segment based on machine learning of a correlation between data collected before.

The individual LOF calculating module may be configured to calculate the LOF of the pipe segment using an estimated cumulative hazard function in terms of a Breslow estimator of a baseline hazard function. The individual LOF calculating module may be configured to calculate the LOF of the pipe segment using an estimation of a baseline survival curve by an extended Breslow estimator. Accordingly, it becomes possible to predict the LOF in the more distant future, and to apply the prediction to the formulation of a long-term repair plan, etc.

A second aspect of this disclosure provides a method for predicting a failure occurring in an underground pipe network by a computer. The method comprises reading connection data. The connection data comprises data indicating at least one pipe segment and data indicating at least one valve. An end of each pipe segment is connected to an end of another pipe segment or a valve. The method further comprises automatically creating data indicating at least one cluster from the connection data. Each cluster comprises one or more of the at least one pipe segment which forms a connection network between one or more of the at least one valve. The method comprises calculating a cluster likelihood of failure (LOF) of each cluster by summing LOFs of the pipe segments included in the cluster, and displaying, on a display device, the at least one cluster and the LOF of each cluster.

The method may further comprise reading population prediction data per area, and displaying, on the display device, the population prediction data in addition to the data indicating the at least one cluster and the LOF of each cluster.

The method may comprise calculating an LOF of the pipe segment based on machine learning of a correlation between data collected before. The calculation of LOF of at least one pipe segment may comprise calculating an estimated cumulative hazard function in terms of a Breslow estimator of a baseline hazard function. The calculation of LOF of at least one pipe segment may comprise calculating an estimation of a baseline survival curve by an extended Breslow estimator.

A third aspect of this disclosure provides an apparatus comprising at least one processor, and at least one memory communicating with the at least one processor. The at least one memory comprises computer-executable instructions. When the instructions are executed by the at least one processor, the instructions cause the at least one processor to execute the method for predicting a failure occurring in an underground pipe network.

A fourth aspect of this disclosure provides a non-transitory computer-readable storage medium comprising a computer program. When the program is executed on a computer, the program causes the computer to execute the method for predicting a failure occurring in an underground pipe network.

In the present disclosure, a failure of a pipe segment refers to a condition in which the delivery through the pipe segment is insufficient or impossible due to a break in the pipe segment or the like. For example, when the pipe segment is a water pipe, a case in which leakage (water leakage) occurs due to breakage is regarded as a failure. In this disclosure, the terms, “failure”, “damage”, and also “leakage”, are often used interchangeably.

### BRIEF DESCRIPTION OF DRAWINGS

FIG. 1 is a schematic view illustrating a configuration of a pipe failure prediction apparatus according to an embodiment of the present disclosure.

FIG. 2 is a schematic view of a pipe failure prediction system that may include a pipe failure prediction apparatus according to one embodiment of the present disclosure.

FIG. 3 shows an example of an underground pipe network including pipe segments and gate valves.

FIG. 4 is a simplified view of FIG. 3.

FIG. 5 is a view illustrating intersections of two pipe segments.

FIG. 6 is an example of displaying LOF in a cluster unit on a map.

FIG. 7 is an example of a display in which a population forecast is superimposed on the LOF of underground pipes.

FIG. 8 is an example of a display in which a population forecast is superimposed on the LOF of underground pipes.

FIG. 9 is an example of a display in which a population forecast is superimposed on the LOF of underground pipes.

FIG. 10 is an example of a display in which a population forecast is superimposed on the LOF of underground pipes.

FIG. 11 is an example showing the location of pipe segments, the projected population density and the projected rate of population change.

FIG. 12 shows an example of a GUI for filtering the display of FIG. 11.

FIG. 13 shows a filtered display input using the GUI of FIG. 12 for the display of FIG. 11.

FIG. 14 shows an example of a Breslow estimate of a survival curve.

FIG. 15 is an example of the linear regression of FIG. 14.

FIG. 16 is an example of the average failure probability of a long-term LOF prediction procedure applied to each material of a pipe segment.

FIG. 17 is an example of the average failure probability of a long-term LOF prediction procedure applied to each joint type of a pipe segment.

FIG. 18 is an example of an area-based risk heat map from a long-term LOF prediction procedure.

FIG. 19 is an example of an area-based risk heat map from a long-term LOF prediction procedure.

FIG. 20 is an example of an area-based risk heat map from a long-term LOF prediction procedure.

FIG. 21 is a flowchart illustrating an example of a computer-based method of predicting a pipe failure, according to an embodiment of the present disclosure.

FIG. 22 is a view showing an example of a hardware configuration of a device for executing a pipe failure prediction method according to the present disclosure.

### DESCRIPTION OF EMBODIMENTS

The following is a detailed description of the embodiment of the present disclosure.

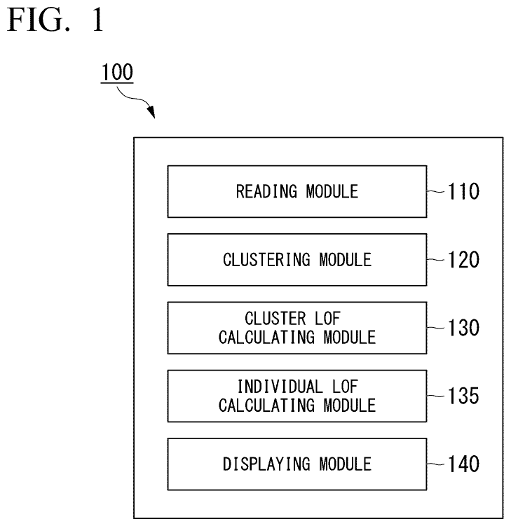

FIG. 1 is a schematic view illustrating a configuration of a pipe failure prediction apparatus 100 according to an embodiment of the present disclosure. The pipe failure prediction apparatus is an apparatus which predicts a failure occurring in an underground pipe network.

The pipe failure prediction apparatus 100 of FIG. 1 includes a reading module 110, a clustering module 120, a cluster likelihood of failure (LOF) calculating module 130, and a displaying module 140. The pipe failure prediction apparatus 100 may include an individual likelihood of failure (LOF) calculating module 135 in addition to the cluster LOF calculating module 130 or in place of the cluster LOF calculating module 130.

These modules 110 to 140 may be included in the same housing, or some or all of them may be in separate housings. The functions of the modules may be implemented by hardware or software. In particular, the functions of the modules may be implemented in a cloud server system.

Further, modules or components other than the modules 110 to 140 may appropriately be added, depending on the application of the pipe failure prediction apparatus 100.

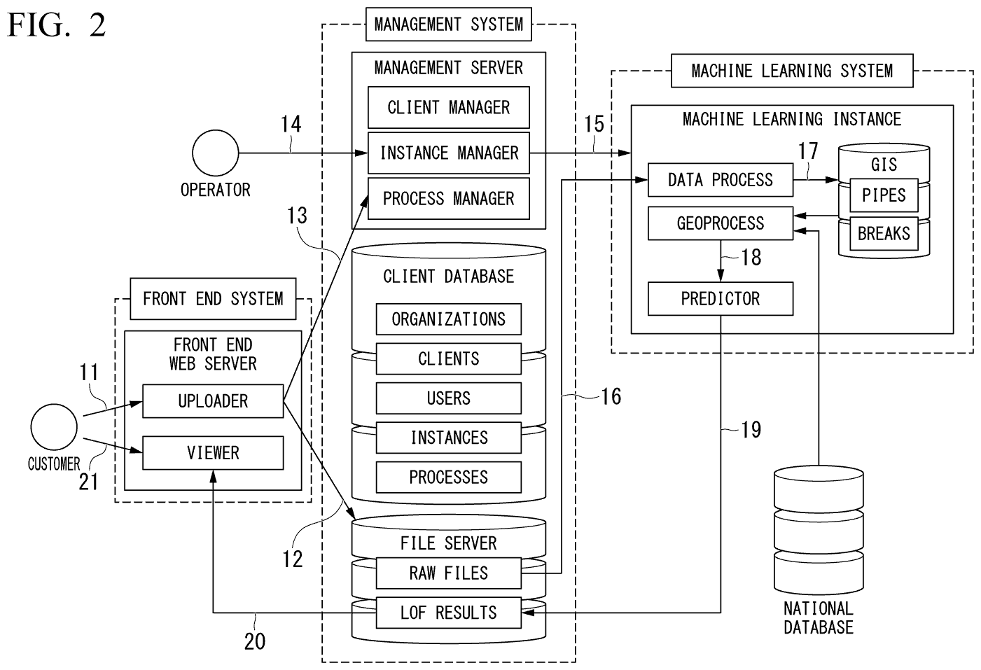

The pipe failure prediction apparatus 100 of FIG. 1 can constitute a part of the pipe failure prediction system of FIG. 2. The pipe failure prediction system of FIG. 2 includes a front end interface, a management system and a machine learning system. The front end interface includes: a page for uploading pipe data, break data, and any supplemental data; a page for viewing basic statistics on pipe network, breaks, and end-of-useful life statistics; a page for viewing the results of the machine learning analysis in both a map view and with supplemental statistics; a page for downloading maps of cleaned data and machine learning results as well as downloading statistics; and an interface allows small utilities to access a solution of a pipe failure prediction company, even without the right data or software. The management system includes: a management server for the creation of instances and processes; a database containing client information; and a file server for hosting files. The machine learning system (instance) includes: scripts for spatial joining, geoprocessing, and machine learning; and a temporary database for hosting files.

Regarding the pipe failure prediction system of FIG. 2, in step 11, the customer logs in and uploads data. In step 12, the customer's data is uploaded and in step 13, a request is made to the process manager of the management server. In step 14, the operator (i.e. the pipe failure prediction company operator) logs in and issues a request to the instance manager of the management server. In step 15, the instance manager issues a request to the machine learning instance of the machine learning system. In step 16, the raw files from the file server are loaded to the data process of the machine learning instance. In step 17, the data process inserts pipes and break data in the geographic information system (GIS) database. The geoprocess receives information from the GIS and the national database. In step 408, the geoprocessed information is fed to the predictor. In step 19, the predicted results are transferred to the likelihood of failure (LOF) results on the file server. In step 20, the LOF results are uploaded to the front end viewer. In step 21, the customer logs in and views/downloads the LOF data.

Next, the Valve-Isolated Segment (VIS) evaluation function is described. This function can cluster underground pipe segments that form underground pipe network so as to predict failure risk for each cluster. The VIS evaluation function provides the VIS LOF when the pipe segment LOF results are uploaded to the front-end viewer in step 11 of FIG. 2, and enables the front-end viewer to display the VIS LOF.

The pipe failure prediction apparatus 100 of FIG. 1 includes the following procedure. The reading module 110 is configured to read connection data. The connection data includes data indicating one or more pipe segments (each pipe in the pipeline). The connection data also includes data indicating one or more valves. The end of each pipe segment is connected to the end of another pipe segment or a valve.

This specifies the positions of the gate valves in the underground pipe network. The connection data can be read from data held by a business company (e.g., a water utility, water utility company). Alternatively, the user can specify the connection data by other means such as reading data from another database or reading user input.

The position information indicating the specified positions of the gate valves may be displayed on a map screen of the pipe failure prediction system, for example, in a form of a plot.

Each valve is associated with the nearest pipe segment to establish a direct link. When two or more pipe segments share a valve, they are considered to be part of the same cluster. However, they are directly connected only if the network specifies such an association. In other words, a valve must be specified in the pipe network data to connect two or more pipe segments.

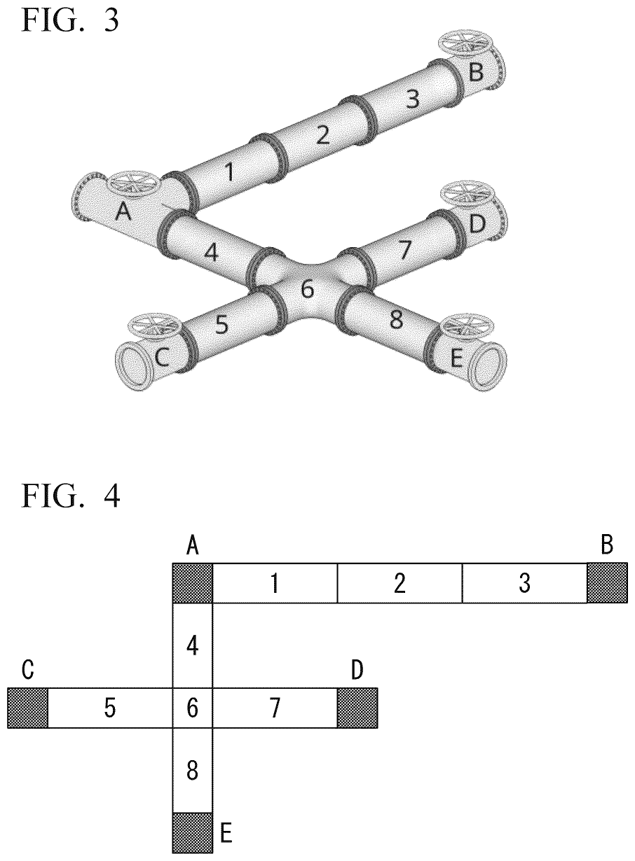

FIG. 3 shows an example of an underground pipe network including pipe segments 1 to 8, and gate valves A to E. The numbers 1 to 8 assigned to each pipe segment are pipe segment identifiers (IDs). The symbols A to E of the gate valve are the IDs of the gate valves. FIG. 4 is a simplified view of FIG. 3.

For example, two ends of the pipe segment 4 are connected to the pipe segment 6 and the valve A, respectively.

The clustering module 120 is configured to automatically generate data indicating one or more clusters from the connection data. Each cluster contains pipe segments that form a network of connections between valves. In this way, the section (cluster) divided by the gate valve is defined as one VIS.

Referring to FIG. 3 or FIG. 4, a VIS1 consisting of pipe segments 1 to 3, and a VIS2 consisting of pipe segments 4 to 8 are present. The VIS1 and VIS2 are separated from each other by a gate valve A. Therefore, for example, even if a leakage occurs in the pipe segment 2, the leakage does not affect the VIS2 by closing the gate valves A and B.

One or more VISs included in FIG. 3 can be specified based on the pipe segments 1-8, the gate valves A-E included in FIG. 3, and the connection data indicating the connection between them. For any underground pipe network, it is possible to cluster underground pipes to automatically obtain multiple VISs by applying an algorithm known as depth-first search to a graph with the gate valves as vertices and one or more pipe segments between the gate valves as edges. The technique for automatically generating one or more clusters from the connection data in the clustering module 120 may use another algorithm, and is not particularly limited.

The pipe failure prediction apparatus 100 of the present disclosure can cluster, by using the connection data, even a three dimensional underground pipe network that is not planar.

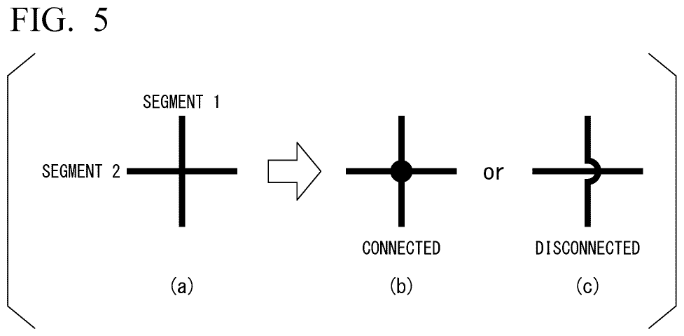

For example, FIG. 5 shows a case in which the intersection of the pipe segment 1 and the pipe segment 2 is projected onto a plane. When the pipe segment 1 and the pipe segment 2 are exposed by removing the soil or the like covering the pipe segment 1 and the pipe segment 2, a photograph as shown in FIG. 5a may be obtained. In this case, even if the pipe segment 1 and the pipe segment 2 intersect each other in the projection plane, there can be cases in which they are actually connected (that is, a case wherein the medium in the pipe segment 1 can flow to the pipe segment 2 through the intersection point, in FIG. 5 (b)) and a case wherein they are not actually connected (a case wherein the pipe segment 1 and the pipe segment 2 have no intersection point and the medium in the pipe segment 1 does not flow to the pipe segment 2, in FIG. 5 (c)).

As is described above, when only the projection plane, that is, the underground pipe network is simplified and represented in a plane, the clustering may not be accurate. In contrast, the use of connection data enables accurate clustering even for non-planar underground pipe networks.

The cluster LOF calculating module 130 is configured to calculate an LOF for each cluster by summing the LOFs of the pipe segments included in each cluster. This enables the calculation of the LOF for each VIS. More specifically, the sum of the LOFs of each pipe segment of one or more pipe segments included in one VIS is defined as the LOF of the VIS. The LOF of each pipe segment may be calculated in the individual LOF calculating module 135. The function of the individual LOF calculating module 135 will be described later.

The identified VIS may be stored in a database and managed together with the calculated LOF value. Additionally, faults associated with pipe segments included in the VIS may also be linked to the VIS, ensuring comprehensive data management and analysis capabilities.

The displaying module 140 is configured to display data indicating one or more clusters and the LOF of each cluster on a screen of a display device. The display device may be co-located with the pipe failure prediction device 100 or may be located at another location, particularly at a remote location.

On the screen, the VIS is converted into map tiles. The map tiles in the VIS may be similar to existing visualizations of pipes and faults. This allows users to visually explore VIS clusters on a geographical map, which helps the users to identify high-risk areas in a short time. The visualization on the map is enhanced to include VIS identifiers, making it easier for the users to understand the distinction between VISs and the specific risks associated with each VIS cluster.

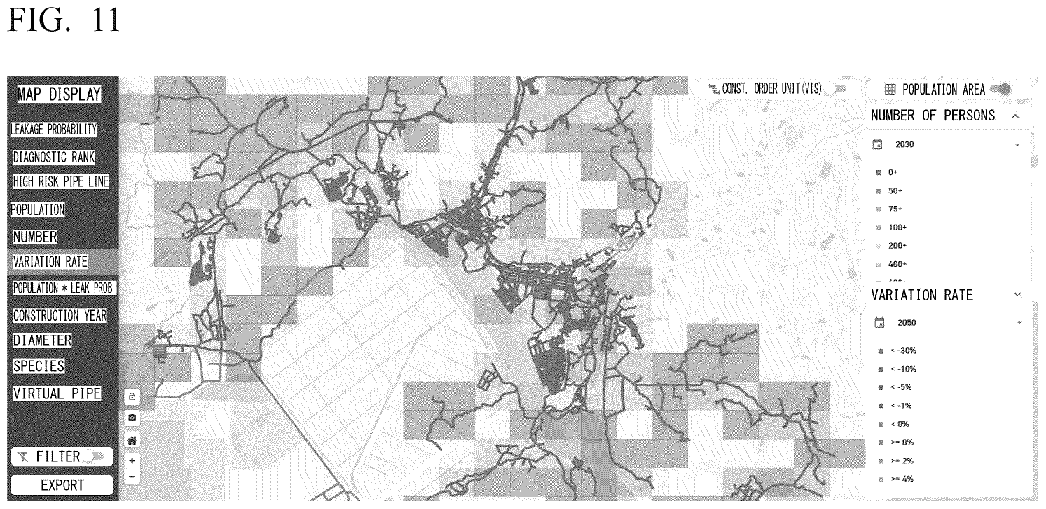

The one or more clusters and the LOF of each cluster may be displayed on a map screen displayed on the display device to indicate the geographic location of the underground pipe network. For example, the LOF for each VIS can be displayed in the color assigned to the VIS on the map screen of the pipe failure prediction system. Alternatively, a graphical user interface (GUI) part (see, for example, a toggle switch of “construction order unit (VIS)” in FIG. 11) for switching between LOF of each pipe segment and LOF of VIS may be provided on the map screen of the pipe failure prediction system.

In addition, an API may be provided for accessing data associated with the VIS, such as an API for identifying the LOF value of the VIS cluster. Such an API allows integration with other systems and supports detailed data export and analysis. Users can export data related to VIS and LOF values of VIS into a file with a format suitable for offline analysis and reporting.

The user interface (UI) includes an option to switch between VIS layers on the map, providing a user-friendly mechanism for analyzing clustered data. For example, by clicking on a VIS cluster, more information may be displayed in the sidebar.

In the conventional pipeline degradation diagnosis, the evaluation is displayed for each pipe segment having an ID, and therefore, the display is sometimes excessively detailed, and it is difficult for users to plan the construction since the displayed data does not fit actual construction sections. The actual construction section is sometimes carried out in VIS units partitioned by valves. According to the pipe failure prediction apparatus 100 of FIG. 1, such a problem is solved by displaying the LOF for each VIS.

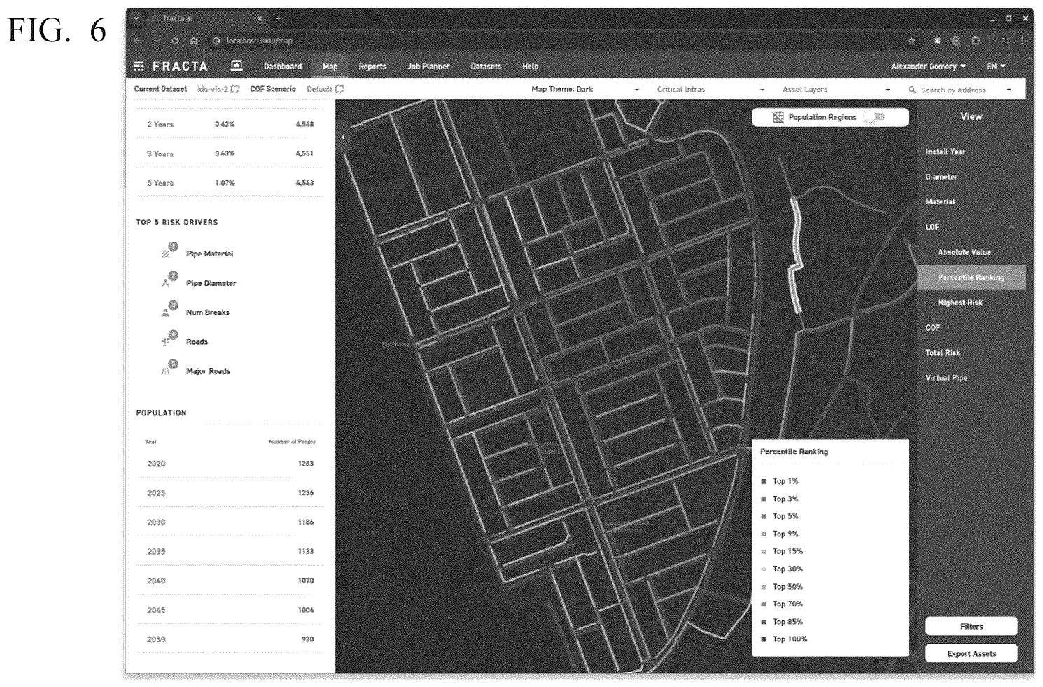

FIG. 6 is an example of displaying the LOF of each cluster on the map. In FIG. 6, the percentile ranking from the small value to the large value is displayed for the LOF for each VIS. Each VIS is displayed in a color or shade according to the percentile ranking. Referring to FIG. 6, it is possible to consider a repair plan based on a construction unit by assigning a priority from the highest LOF (leakage risk).

As described above, the pipe failure prediction apparatus 100 according to the present disclosure automatically clusters all pipe segments forming a network between the shutoff valves, creates a comprehensive VIS, and improves the visibility of the network. Assigning a cluster-wise LOF to each VIS may allow a better understanding of the risk distribution across the pipe network.

In general, the pipe failure prediction device 100 according to the present disclosure can be utilized for formulating a repair plan that achieves both risk assessment and enhancement of asset allocation. That is, instead of focusing only on individual pipe segments, it is possible to obtain a clearer picture of the state of the pipe network at the level of roads and neighborhoods. This broad perspective helps to optimize resource allocation and plan for maintenance or replacement activities.

Next, another example of the present disclosure relating to the integration of information on the prediction of future population change and the leakage risk of underground pipe network (especially, water pipe) is described.

The conventional evaluation of the degree of importance of underground pipe network was based on the location of facilities such as hospitals and schools wherein the supply (water supply) should not be stopped in an emergency.

In recent years, in addition to the primary functions of water supply facilities (water intake facilities, water storage facility, water transmission facilities, water purification facilities, water transmission facilities, water distribution main pipes, water distribution ponds, etc.), facilities that are highly likely to cause serious secondary disasters are classified as important water supply facilities.

However, as the risk of leakage of underground pipes becomes more serious, it takes a huge amount of money and time to replace all pipes and to take measures against the aging pipes. Therefore, it is necessary to improve the efficiency of these measures and to further optimize the order of priority.

The pipe failure prediction device 100 according to the present disclosure may have a function of displaying the degree of influence, that is, how many residents are affected when the supply is stopped. If it is possible to visualize how many residents will be affected by the water outage in an emergency, it is possible to propose an option of proceeding with the renewal of pipelines with priority given to those that will affect many residents.

It is desired to provide administrations or operators with important insights into future population trends in different geographical regions. By overlaying the map with projected population changes and LOF of individual pipe segments and/or VISs, the operating company can help optimize capital allocation, and investment in pipe repair or installation is financially justified by future demand.

In another example of the present disclosure, the reading module 110 of FIG. 1 may be further configured to read current population data by region. Alternatively, the reading module 110 of FIG. 1 may be further configured to read population forecast data for a period of time in the future for each region. The “region” may be an administrative or business unit such as a municipality, a block, or a block number, a grid divided at appropriate intervals (for example, 1 kilometer) on a map, or the entire display area.

The population data or the population forecast data may be, for example, one or more of the population itself, the population density, or the population change rate, but the present disclosure is not limited thereto. For simplicity, the term “population forecast data” can mean both “current population data” and “population forecast data for a certain time in the future”.

The population forecast data is provided by, for example, the Ministry of Land, Infrastructure and Transport (MLIT) of Japan as a shapefile with polygonal geometry. The data is disaggregated by region and includes population estimates by age and sex for the years 2020, 2025, 2030, 2035, 2040, 2045 and 2050.

The population forecast data may be obtained by extracting only data on the absolute number of people from the data held by the national and local governments, excluding information on age and sex for the purpose of simplification. Such abbreviated data may include identifier, prefecture, area code, shape and population (the years 2015, 2020, 2025, 2030, 2035, 2040, 2045, and 2050).

For each pipe segment (represented on the map by a multi-line or line geometry), a buffer is generated around each pipe segment with a user-defined radius for display on the map. This buffer represents the potentially affected area if the pipe fails. For each pipe buffer, the intersecting population polygons (polygons indicating the areas giving the population of the population prediction data) are considered to be affected (threatened) by potential pipe failures. The total population within these polygons represents the number of customers affected during service disruptions. This logic is also applied to the VIS cluster, aggregating the affected population at all pipe segments in the VIS.

In particular, the population density data read by the reading module 110 may be automatically linked to the underground pipe data of each operating company. This function provides the ability to display the population density data associated with the LOF of the pipe segment or VIS in the front-end viewer when the LOF results of the pipe segment or VIS are uploaded to the front-end viewer in step 11 of FIG. 2.

The displaying module 140 may be further configured to display one or more clusters and an LOF for each cluster, as well as population forecast data. The LOF of underground pipe network is displayed for each pipe segment or for each VIS. The displaying module 140 can display the population prediction data for each region on the map in, for example, a color or a shade of a translucent mesh.

In particular, the future supply population can be visualized. For this purpose, a mesh map based on future population projections is superimposed on the LOF of the underground pipe. The displaying module 140 may display translucent polygons representing population data, the colors of which dynamically change based on expected population changes. This visual representation allows users to easily identify areas with increasing or decreasing populations.

Alternatively or additionally, a drop-down menu may allow the user to select a year from the first year after the current year (e.g., 2025, 2030, or 2035) for viewing population projections. This will ensure that the data is adequate and consistent with future planning periods.

The population polygons are overlaid on the existing LOF and/or VIS on a map, simultaneously visualizing both the risk of failure and future population trends. This integration may help to identify areas where investment in pipeline infrastructure may be more or less justified, based on future population estimates.

The UI may be dynamically updated to show the estimated number of customers affected (water outage) based on the selected year and projected population data. This function provides a specific measure of the impact of pipeline failure or maintenance activities.

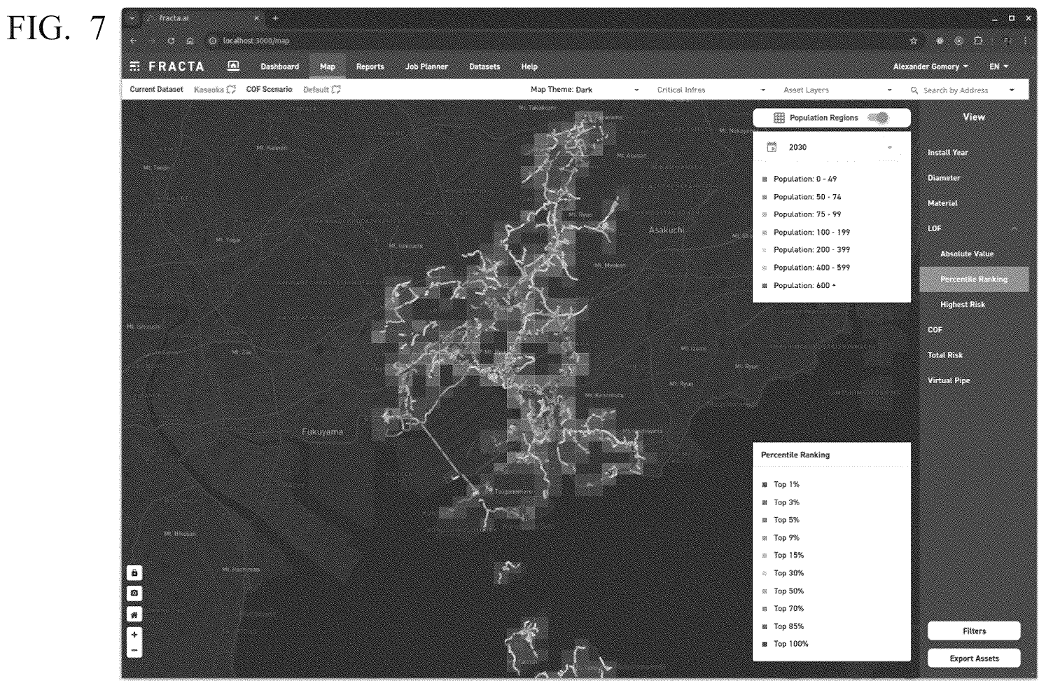

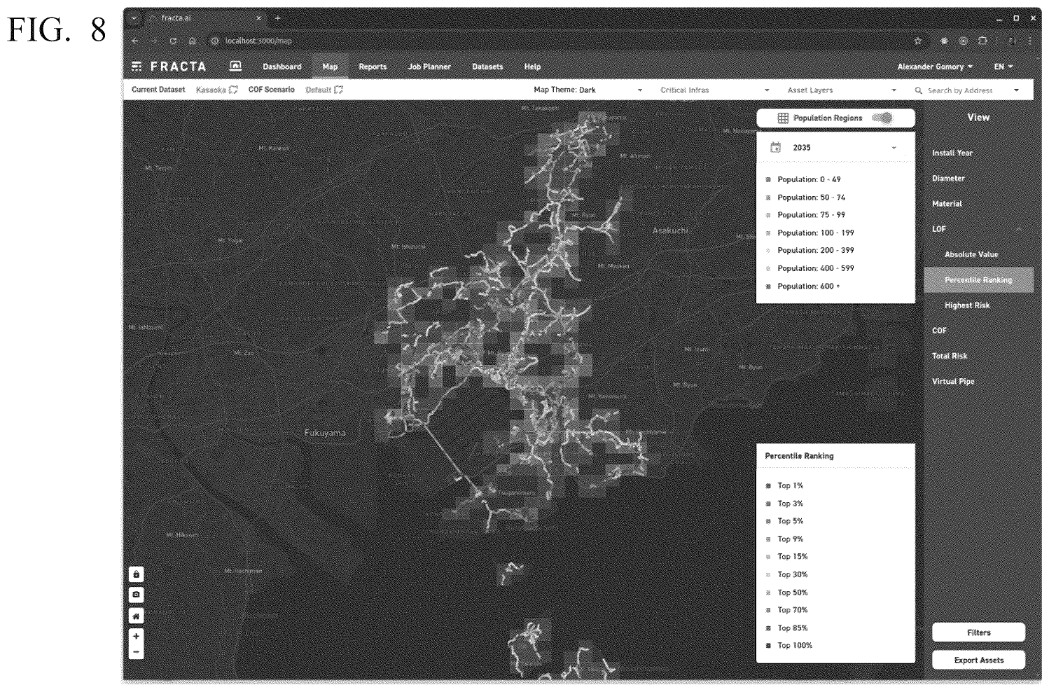

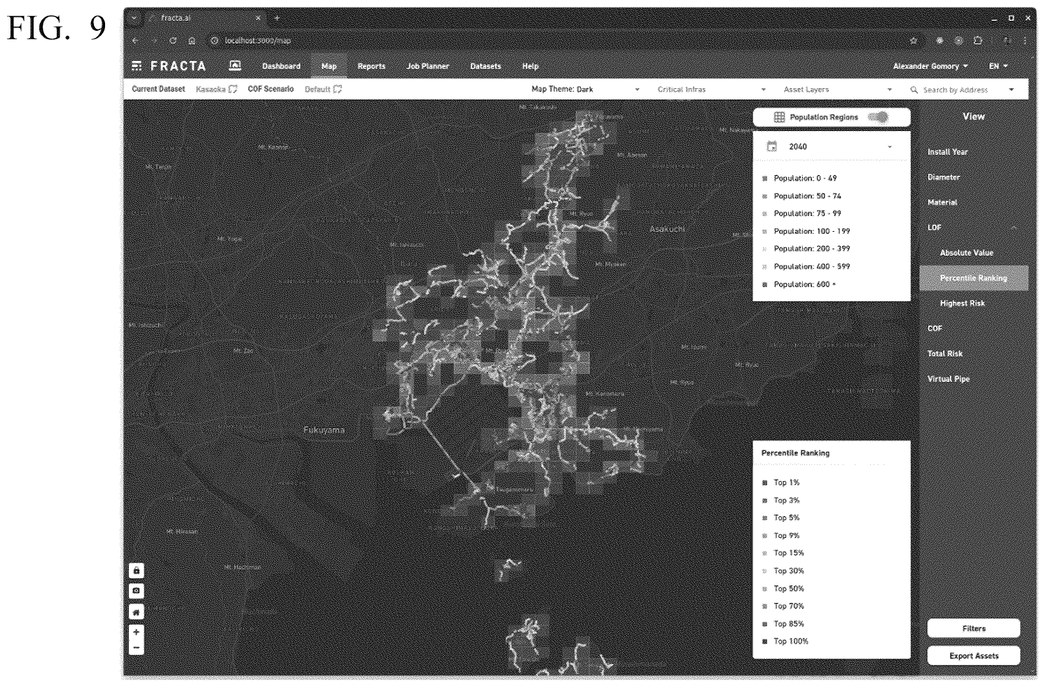

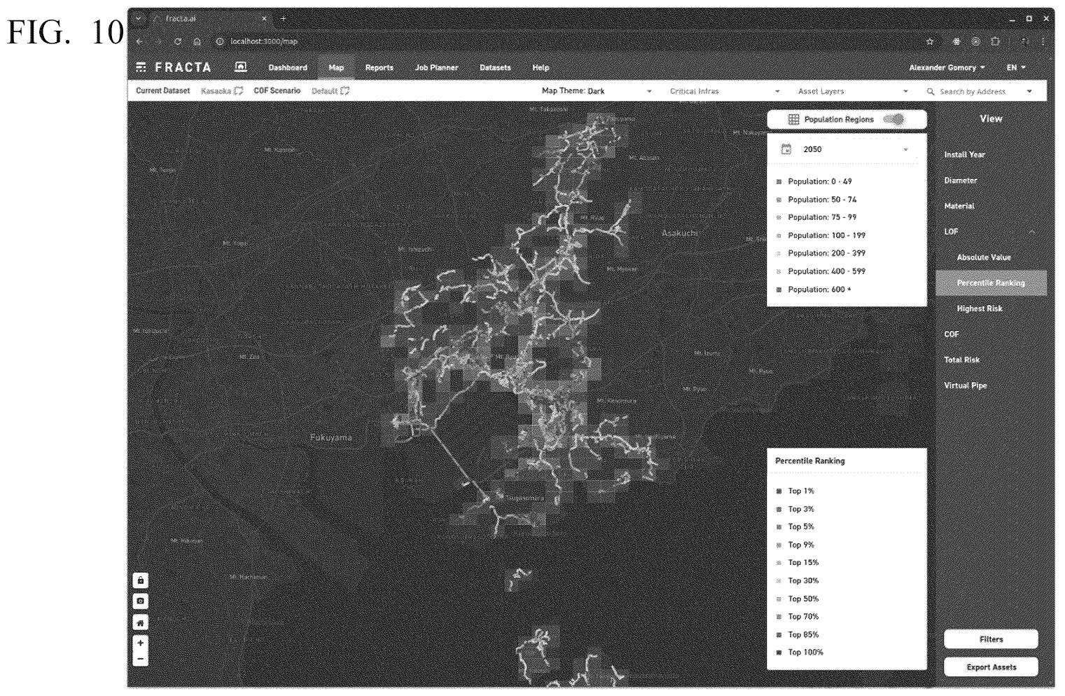

Referring to FIGS. 7, 8, 9 and 10, which can be displayed by the pipe failure prediction apparatus 100 according to the present disclosure, a display in which the population prediction is superimposed on the LOF of the underground pipe is described.

For example, FIG. 7 shows the LOF of underground pipe and the projected population in 2030. The LOF of the underground pipe is displayed in a color or a shade in accordance with the percentile ranking of the LOF as in FIG. 6. The projected population as of 2030 is displayed in a grid-like area on the map, with the area colored or shaded according to the percentile ranking of the projected population in the area. The percentile ranking of the predicted population in FIG. 7 is equivalent to the percentile ranking by the predicted population density because it is for the area divided in a grid shape at equal intervals on the map.

Similarly, FIGS. 8, 9 and 10 show the LOF of the underground pipe and the projected population in 2035, 2040 and 2050, respectively, superimposed on the LOF.

Thus, the map can be used to visualize how the population currently supplied with water will change in the future and the LOF forecast of underground pipe. This enables the importance to be evaluated in consideration of the population prospect. In particular, it will be possible to draw up a repair plan that anticipates future toll revenues.

Furthermore, the population change rate may be displayed in addition to or instead of the predicted future population. In particular, the population change rate may be displayed in a color, shade, or the like attached to the pipe segment or VIS.

Referring to FIGS. 11, 12, and 13, which can be displayed by the pipe failure prediction apparatus 100 according to the present disclosure, the display of the LOF of the underground pipe superimposed with the population prediction and the population change rate is described.

FIG. 11 shows the positions of the pipe segments, and shows the population density in 2030 predicted for each area by the color or the shade of the translucent mesh, and the population change rate in 2050 predicted for each pipe segment by the color or the shade of the pipe segment.

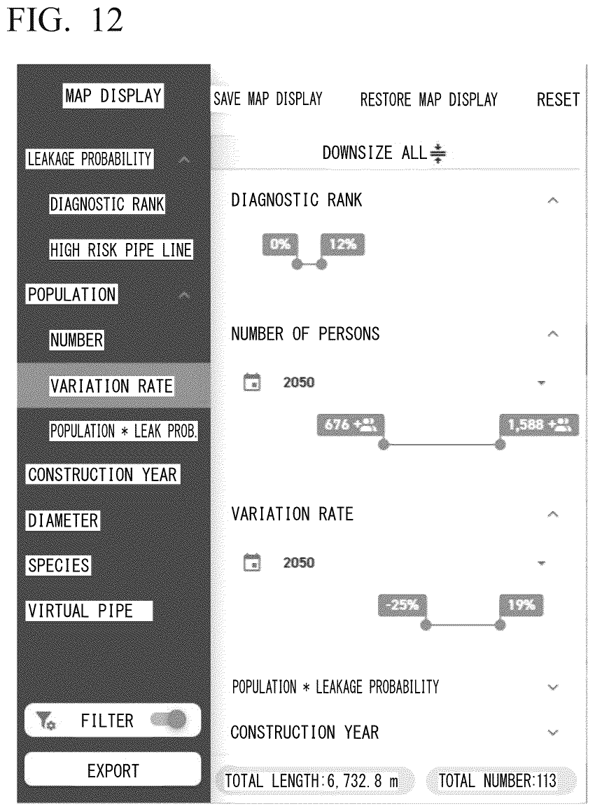

FIG. 12 shows an example of a GUI for filtering the display of FIG. 11. In FIG. 12, only pipe segments having a water leakage probability (failure probability) in the range of 0 to 12% are shown, and the number of people in 2050 is increased in the range of 676 to 1588, and the change rate in 2050 is filtered to be in the range of −25 to 19%.

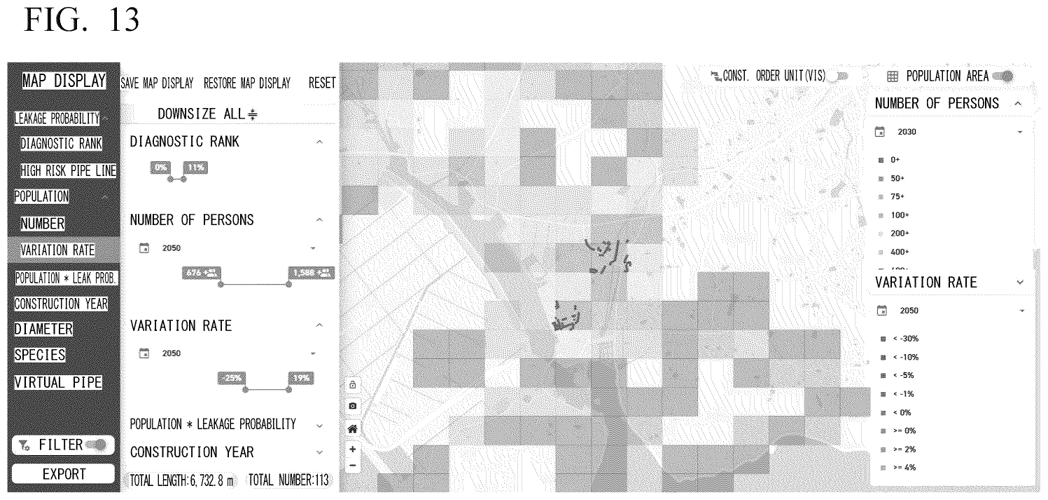

FIG. 13 shows a display in which filtering input by the GUI of FIG. 12 is performed on the display of FIG. 11. In this way, future population distributions and change rates can be overlaid with the occurrence of faults, which may help effectively formulation of a renovation plan.

In another example of the present disclosure, the pipe failure prediction device 100 may include an individual LOF calculating module 135 in addition to or in place of the cluster LOF calculating module 130. The individual LOF calculating module 135 may be configured to calculate an LOF of a pipe segment based on machine learning of correlations between previously collected data. The cluster LOF calculating module 130 may calculate an LOF for each cluster by summing the LOF for each pipe segment calculated by the individual LOF calculating module 135.

The collected data includes pipeline data and failure history. The collected data may further include environmental big data composed of various environmental information surrounding the pipes. The pipeline data includes, for example, information (pipe diameter, length, material, construction year, etc.) of a pipe segment (water pipe). The failure history is, for example, a water leakage history. The pipeline data and the fault history are digitized, corrected, and/or supplemented as necessary. Big environmental data includes data on population, soil, rivers, transportation networks, earthquakes, etc., and is based on a database of vast variables that is constructed throughout Japan, for example.

Long-term LOF prediction by the individual LOF calculating module 135 is described. Here, “long-term” generally refers to a period of more than five years, typically 20, 30, 50, and 100 years in the future, but there is no limitation on the upper and lower limits. Conventional approaches do not predict such long-term LOFs, due to the constraints by the range of years observed in the training data. The long-term LOF prediction function of the present disclosure is implemented by employing the following method in the machine learning instance of FIG. 2. This long-term prediction capability enables utility companies to better plan and allocate resources over time, ensuring that infrastructure investments are aligned with future risks. In particular, utility companies may be able to actively manage pipeline infrastructure based on long-term risk forecasting, maintenance schedule optimization, and replacement strategies.

Once the data of the operating company is uploaded first, it is cleaned up and normalized to ensure compatibility with the machine learning model. More than 100 additional variables (features) can be generated based on environmental data, such as soil properties, precipitation, population density, transport properties, etc. These variables provide a comprehensive data set for predicting future pipe failure.

The long-term LOF model used by the pipe failure prediction apparatus 100 of the present disclosure uses historical failure data (if available) to establish correlations between pipe attributes, environmental variables, and failure rates. The model applies advanced machine learning algorithms, discussed below, to predict the probability of pipe failure over a long-term horizon (20, 30, 50, or 100 years). The model accounts for time-dependent variables and estimates future risk based on current and historical data patterns.

The approach described below allows to predict the breakage patterns of a pipe segment of arbitrary length failing on any given year in the future. That is, a random variable Tis modeled that represents the number of years into the future a pipe survives, and with this model, pipe breakages can be simulated in a way that will allow to estimate many useful statistics like breakage probability and expected break count. For this purpose, the target is calculating the probability of failure in year/that the pipe did not fail (“survived”) until year t−1,

$$P ( T = t \vert T > t - 1 ) . \qquad ( 1 )$$

The inventors of the present disclosure have found that the calculation of Eq. (1) can be effectively described and performed by the Cox model used for survival analysis.

Here, the Cox model is described. The Cox model is a methodology in the survival analysis literature for estimating the hazard function under the assumption of proportional hazards. While traditional applications of the Cox model rely on a linear parameterized model on the covariates, a learning-based approach is applied instead in this disclosure through XGBoost's GBDT-based library, which has native support via loss functions tailored to the Cox proportional hazards model. The model in this disclosure assumes that the hazard function should take a form of

$$\hat{h} ( t \vert X ) = {h}_{0} ( t ) \times {e}^{f ( X )} \qquad ( 2 )$$

wherein h(t) is the hazard function and X represents the covariate (feature). The symbol f(X) stands for “hazard ratio”, a learning function that adjusts the baseline hazard h₀(t) based on the values of the covariates. Traditional usage of the Cox model typically defines f(X) as a linear model fitted to the covariates, such as

$$f ( X ) := {β}^{T} X = {β}_{0} + {β}_{1} {X}_{1} + ... + {β}_{n} {X}_{n} . \qquad ( 3 )$$

XGBoost's implementation of the Cox model learns f(X) using the GBDT algorithm with an appropriately defined loss function, the raw model output provides us with T(X)=e^{f(X)}, and it is possible to plug in the output of the fitted GBM model directly to account for this part. However, since h₀(t) must be estimated separately, the canonical method of using the Breslow estimator as defined in the literature is modified, with some extension, to a desired approach.

Many treatments of the Cox model avoid estimating h₀(t) entirely. In fact, one of the great advantages of the proportional hazards assumption is that it is still able to compare relative risks merely by estimating e^{f(X)} and ignoring the scaling factor h₀(t) entirely as it is a constant in X. However, e^{f(X)} alone provides nothing about the underlying absolute risk. Since the absolute risk is ultimately necessary, h₀(t) needs to be estimated as well.

In the following approach, the Breslow estimator is used, which is a nonparametric method to obtain ĥ₀(t) with given the hazard ratios computed by a fitted model e^{f(x)}. The Breslow estimator is defined in terms of the cumulative hazard function as

$${\hat{h}}_{0} ( {t}_{j} ) = \frac{{δ}_{j}}{{\sum }_{k ∈ ℛ ( {t}_{j} )} {e}^{{\hat{β}}^{T} {X}_{k}}} \qquad ( 4 )$$

$${\hat{H}}_{0} ( t ) = {\sum }_{j : {t}_{j} \leq t} {\hat{h}}_{0} ( {t}_{j} ) \qquad ( 5 )$$

wherein \hat{β} represents regression coefficients obtained by machine learning, δⱼ represents a total number of events (failure) at time j, and [symbol] (tⱼ) represents a set of individuals (e.g., pipe segments) still at risk at time j.

The time/satisfies t0<t<t1, wherein t0 and t1 are constants representing an upper limit and a lower limit, respectively. Typically, t0=0 and t1=30 (in years). By substituting f(X) for β^{T}X, an estimator Ĥ₀(t) for the baseline cumulative hazard function is obtained. The individual LOF calculating module 135 may be configured to calculate a Breslow estimator of the baseline hazard function using Eqs. (4) and (5).

The original goal is to estimate the value of Eq. (1) rather than the hazard function. The hazard function provides nothing about the underlying probabilities but rather the actual breakage probability on each year. In survival analysis, this typically comes from the survival curve S(t), which represents the inverse cumulative distribution function of the random variable T. The cumulative hazard function is generally related to S(t) by the definition:

$$H ( t ) := - log S ( t ) ⇒ S ( t ) = {e}^{- H ( t )} . \qquad ( 6 )$$

Applying the definition of the cumulative hazard

$$H ( t ) = {\int }_{0}^{t} h ( s ) ds$$

alongside the Cox model definition, the following relation is obtained

$$\begin{matrix}S ( t \vert X ) = exp [ - H ( t \vert X ) ] \\ = exp [ - {\int }_{0}^{t} {h}_{0} ( s ) \times {e}^{f ( X )} ds ] \\ = exp [ - {e}^{f ( X )} {\int }_{0}^{t} {h}_{0} ( s ) ds ] \\ = exp [ - {e}^{f ( X )} \times {H}_{0} ( t ) ]\end{matrix} . \qquad ( 8 )$$

By plugging in the estimated Ĥ₀(t) and e^{f(X)} into (8), the whole survival curve Ŝ(t|X) is estimated for any given observation X.

Although the method to calculate survival curves has been described, the fact needs to be taken into account that the data do not perfectly fit with the assumptions of survival analysis. It is crucial to allow multiple events per subject although the Cox model strictly allows only one event per subject.

The goal in this disclosure is to predict well into the future (typically, 100 years). In order to achieve this, the rules of the model constructed so far needs to be modified, since the Breslow estimator is nonparametric and thus is necessarily constrained to the range of years observed in the training data, which limits predictions up to about t<30 [year]. Generally, the time/satisfies t0<t<t1, wherein t0 and t1 are constants representing an upper limit and a lower limit, respectively. Typically, t0=0 and t1=30 (in years).

To predict the future within the range t1<t<t2 (t2 is a constant, typically t2=100 [year]) for time t, we adopt the following approach is adopted.

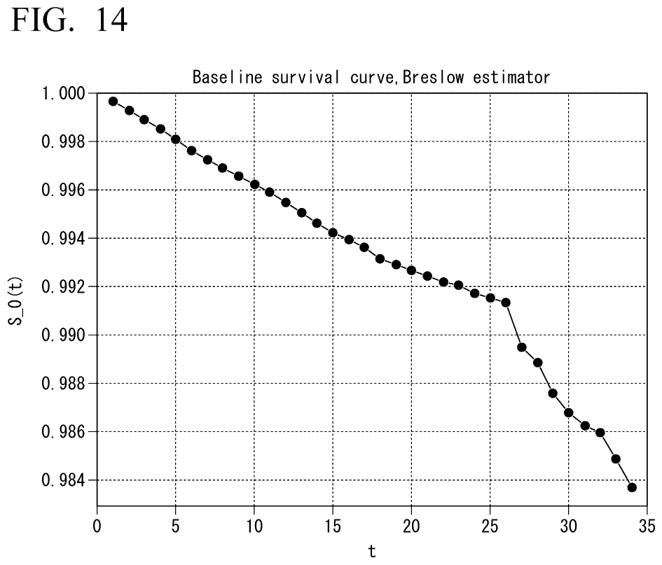

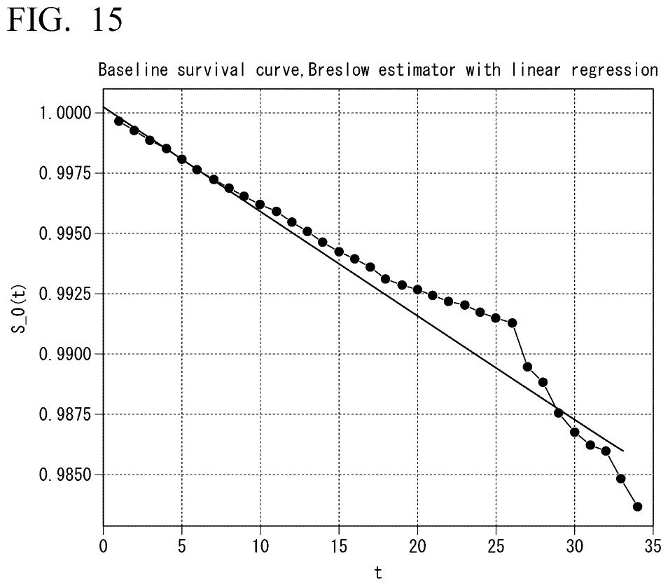

FIG. 14 plots the Breslow estimator of the baseline survival curve exp (−H₀(t)) by the Breslow estimator of the cumulative hazard function (Eqs. (4) and (5)) using the weights learned at 0<t<30. The Breslow estimator of the baseline survival curve shown in FIG. 14 is observed to be approximately linear in the range of 0<t<30. FIG. 15 shows a regression line obtained by the least squares method in the range of 0<t<30.

Based on these findings, the least square approximation in the range of t0<t<t1 (especially, t0=0, t1=30 [year]) giving

$${\hat{S}}_{0} ( t ) = X \hat{β} \qquad ( 9 )$$

is extended beyond the range of t0<t<t1 to t=t2 (especially t2=100 [year]). Although the accuracy of the approximation may drop as/increases, the prediction, which has been limited by the training data, needs a parametrization to extend beyond the training data.

With the estimated survival curve

$$\hat{S} ( t \vert X ) = \hat{P} ( T \geq t \vert X ) , \qquad ( 10 )$$

the full inverse cumulative distribution function (CDF) of T across 100 years can be generated. Using the following simple identity, the survival probability can be adapted to an actual breakage probability, which is necessary to simulate breaks.

$$\begin{matrix}P ( T = t \vert T > {t}_{0} ) = P ( T > t - 1 \vert T > {t}_{0} ) - P ( T > t \vert T > {t}_{0} ) \\ = \frac{1}{S ( {t}_{0} )} [ S ( t - 1 ) - S ( t ) ]\end{matrix} . \qquad ( 11 )$$

From (11) for the special case of t₀=t−1 (the previous time step), the following equality is obtained

$$P ( T = t \vert T > {t}_{0} ) = P ( T = t \vert T > t - 1 ) = 1 - \frac{s ( t )}{s ( t - 1 )} . \qquad ( 12 )$$

By doing this for all of n pipes, an n×100 matrix P can be generated, wherein the matrix element is the breakage probability on year j for pipe i

$${P}_{i , j} = P ( T = j \vert {X}_{i} ) . \qquad ( 13 )$$

With simple random number generation, it is possible to simulate outcomes across all pipes for each year and treat these as simulated breaks. Because past break count is a feature included in the feature set X, each time a simulated “break” occurs, the break count is incremented in X to reflect this updated state and re-run inference on this newly updated data.

Since this naturally results in a rather high-variance output, this simulation is repeated across all 100 years B=100 times to take the average result, thereby bootstrapping the estimates in an effort to reduce variability in the results.

Since X can directly accessed, it is possible to simulate pipe replacement by “refreshing” pipe attribute values in X with whatever values, such as resetting pipe age alongside material type, diameter, and so forth, may be chosen.

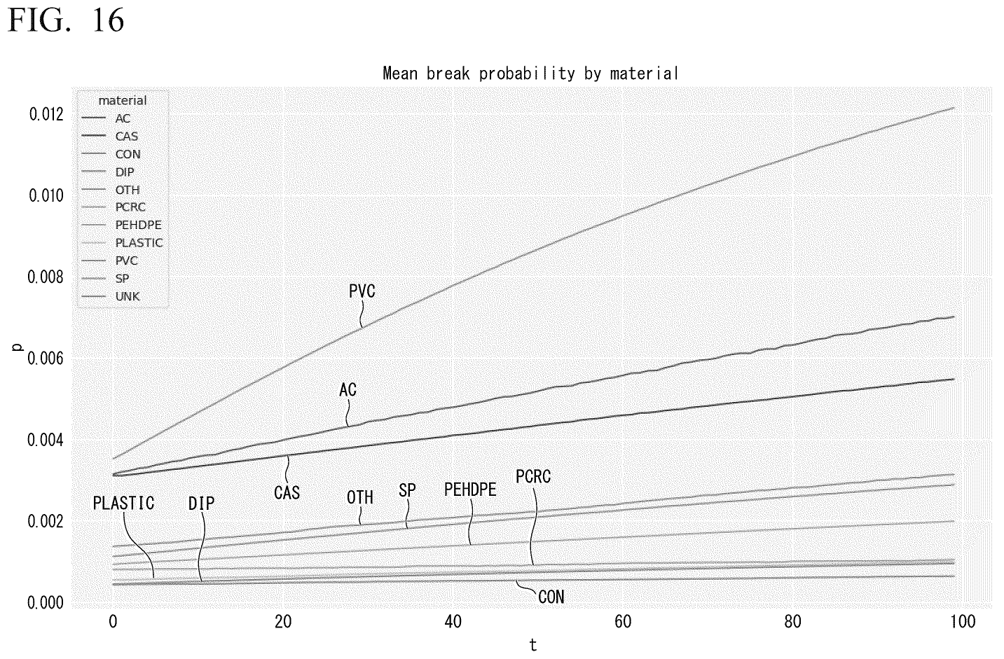

FIG. 16 shows an average failure probability (see Eq. (1)) in year t (t is between 0 and 100) obtained by applying the long-term LOF prediction procedure for each material of pipe segment (AC, CAS, CON, DIP, OTH, PCRC, PEHDPE, PLASTIC, PVC, SP). That is, the covariate (characteristics) X is the pipe segment material, and the average failure probability is calculated from the learning in the range of 0<t<30.

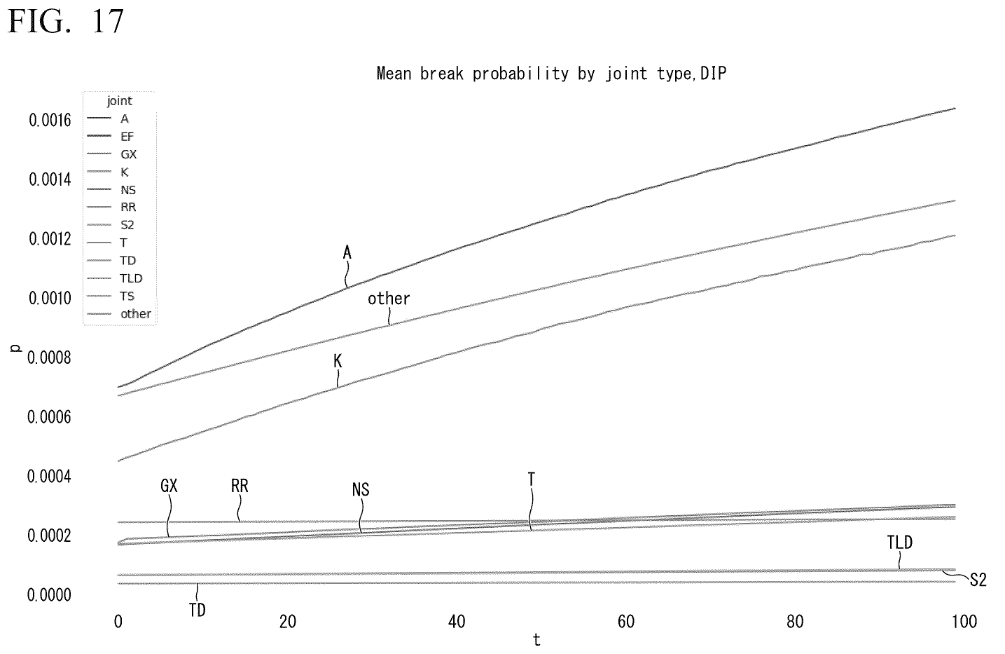

FIG. 17 shows the average failure probability (see Eq. (1)) in year t (t is from 0 to 100) obtained by applying the long-term LOF prediction procedure to each joint (A, EF, GX, K, NS, RR, S2, T, TD, TLD, TS) of a cast iron pipe (DIP). That is, covariate (characteristics) X is the pipe segment joint, and the average failure probability is calculated from the learning in the range of 0<t<30.

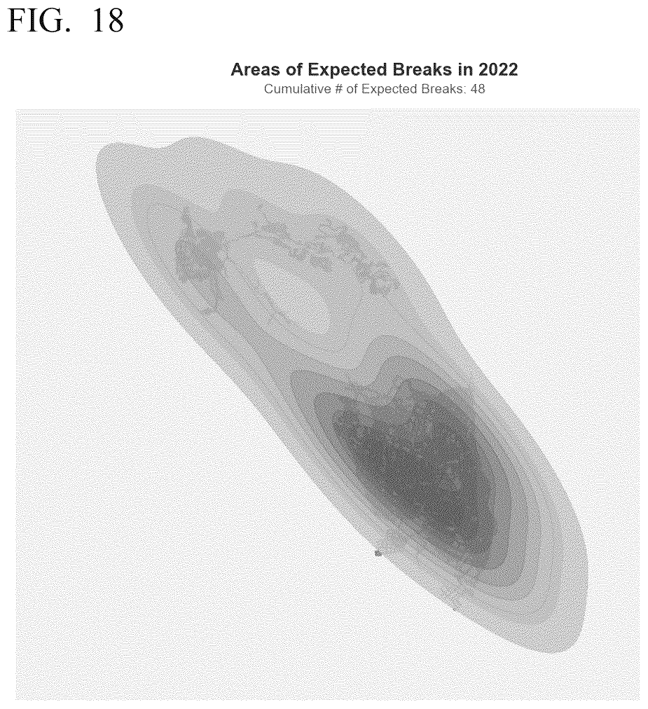

By using these methods, the pipe failure prediction apparatus 100 can predict the LOF in the more distant future (typically 100 years ahead) than ever. FIGS. 18, 19, and 20 are area-based risk heat maps showing the failure risk, which are displayed by applying such a long-term LOF prediction procedure in the pipe failure prediction apparatus 100 according to the present disclosure.

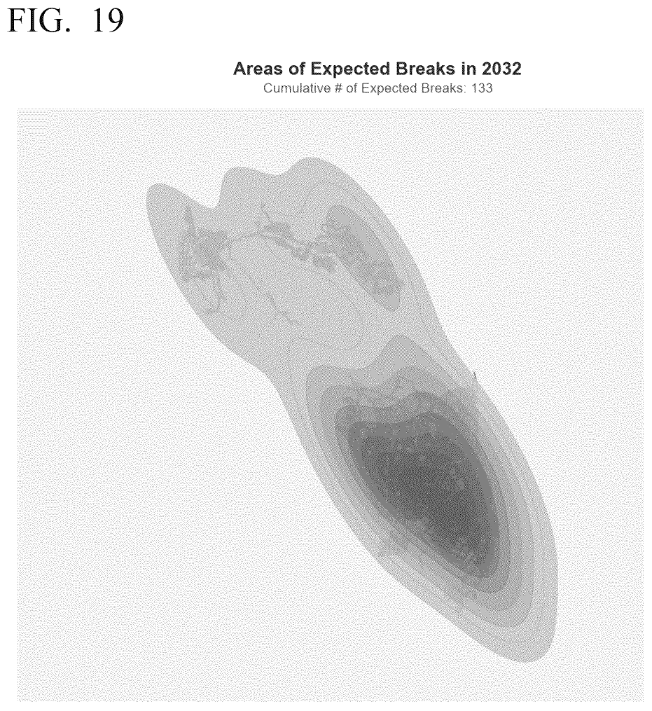

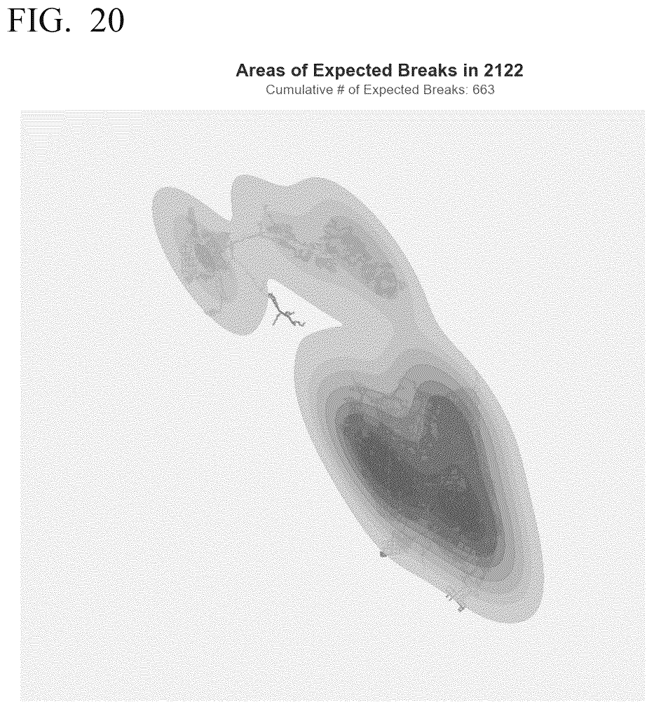

FIG. 18 shows the risk heat map by area as of 2022. A cumulative total of 48 failure risks is projected. FIG. 19 shows the risk heat map by area as of 2032. A cumulative total of 133 failure risks is projected. FIG. 20 shows the risk heat map by area as of 2122 (100 years ahead). A cumulative total of 663 failure risks is projected. The pipe failure prediction device 100 can predict and display such a long-term failure risk.

The displaying module 140 may display the area-based risk heat map in a manner superimposed on the map. As is also seen in FIGS. 11 to 13, long-term LOF predictions may be classified into risk classes and ranked according to predefined thresholds and percentiles. The ranking includes, for example, the following risk categories:
<Highest Risk> Pipe segments with the top 1% LOF.
<Risk level> Absolute risk classification based on predefined LOF buckets (e.g., 50%, 25%, 10%, 5% thresholds corresponding to LOF values of 0.50, 0.25, 0.10, 0.05).
<Risk Rank> Relative risk classification based on percentile buckets (e.g., top 1%, top 3%, top 5%, lower <95th percentile).

The UI functionality may be extended in response to long-term LOF predictions as follows. In the map control, the user selects a forecast period (20, 30, 50, or 100 years) from a drop-down menu on the screen. Such a menu allows users to easily switch between different time frames, which helps the users to assess risk over different time periods.

The data display option allows the user to display data according to a selected risk classification (highest risk, risk level, risk rank, etc.). These options allow users to filter the displayed data based on specific needs, focusing on the highest risk segment or a broader risk classification.

Filters may be added to narrow the data displayed in the map. Users can filter the display by year of installation, material, diameter, and other pipe attributes. This flexibility allows users to drill down to specific areas of interest and analyze segments based on multiple criteria.

The displayed map may be an interactive map. Zoom in and zoom out of the map may be applied by using the mouse scroll wheel or the +/−control at the bottom left of the screen. In an expanded manner, the user may select individual pipe segments by clicking on them to display the risk rank (relative position in the risk distribution), the number of past faults (historical data of pipe faults), the top risk factors (key factors contributing to the risk of pipe faults based on machine learning models), the probability of fault (probability of fault in a selected forecast period such as 20, 30, 50, or 100 years), and other detailed attributes (pipe ID, year of installation, material, full profile of pipe segment such as length, diameter, etc.).

The pipe failure prediction device 100 may provide a user-accessible risk ranking table that ranks pipe segments based on LOF. The risk ranking table contains the following information about the top 1% pipe segments with the highest LOF value: rank, pipe ID, location, year of installation, diameter, length, material, number of failures in the past, LOF in a year, top risk factors, etc.

The pipe failure prediction device 100 may have a function that allows a user to export a report summarizing long-term LOF predictions by segmenting the report by risk class or other attribute. This feature supports in-depth analysis and helps to communicate with stakeholders.

According to the pipe failure prediction device 100 having the long-term LOF prediction function, by extending the prediction period, the operating company can predict future risks, develop a long-term maintenance and replacement strategy, and reduce the possibility of unexpected failure. A long-term LOF forecast provides the basis for a more strategic capital allocation and can reliably target investments to high-risk areas over long periods of time. Access to detailed long-term risk forecasts enables operating company managers to make more informed decisions about pipeline management, balancing short-term needs with long-term goals.

Even in a local government or a business company having a small history of failure (water leakage), the diagnosis of the LOF can be performed by a model (learned model) in which the water leakage tendency and/or pattern of a target local government is learned.

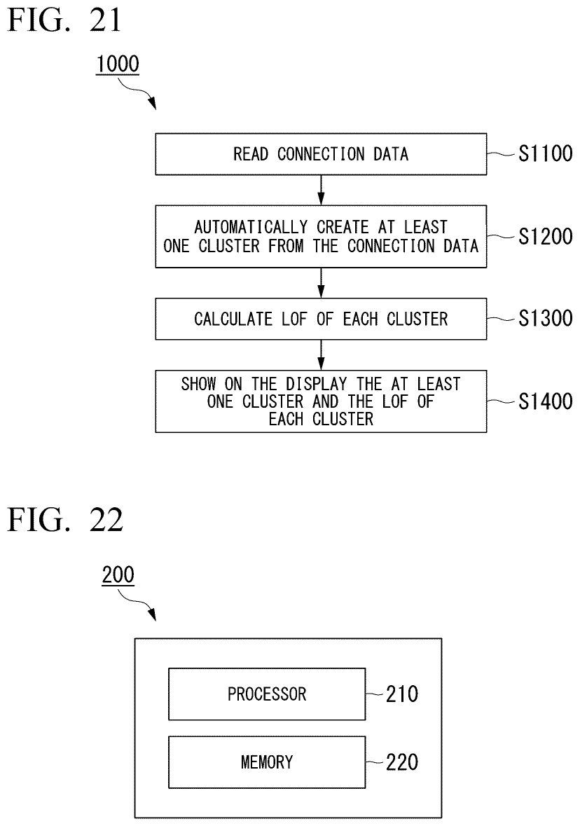

FIG. 21 is a flowchart showing an example of a pipe failure prediction method by a computer according to an embodiment of the present disclosure. A pipe failure prediction method 1000 will be described with reference to FIG. 21.

A pipe failure prediction method 1000 includes a step of reading connection data (S1100), a step of automatically generating one or more clusters from the connection data (S1200), a step of calculating the LOF of each cluster (S1300), and a step of displaying the one or more clusters and the LOF of each cluster on a display (S1400).

In the step of reading the connection data (S1100), the connection data includes data indicating one or more pipe segments and data indicating one or more valves, wherein the end of each pipe segment is connected to the end of another pipe segment or valve to indicate an underground pipe network.

In the step 1200 of automatically generating data indicating one or more clusters from the connection data, each cluster is a VIS including pipe segments forming a connection network between valves.

In the step of calculating the LOF of each cluster (S1300), the LOF of the cluster is calculated by summing the LOFs of the pipe segments included in each cluster.

In the step of displaying data indicating one or more clusters and the LOF of each cluster on the display (S1400), the data indicating the one or more clusters and the LOF of failure of each cluster may be displayed on the map.

According to the pipe failure prediction method 1000, the LOF is displayed for each cluster partitioned by the valve. In general, the effect of failure can be understood for VIS, which is a unit to be separated at the time of repair, and the repair plan can be applied to the unit of cluster which can be stopped by a valve.

Steps other than steps 1100 to 1300 may be added appropriately depending on the application to which the pipe failure prediction method 1000 is applied. Furthermore, the order of execution of the steps may be changed or repeated as appropriate.

The pipe failure prediction method 1000 may further include a step of reading population prediction data for each region, and displaying the population prediction data in addition to the data indicating one or more clusters and the LOF of failure of each cluster on the display.

The pipe failure prediction method 1000 may calculate an LOF of the pipe segment based on machine learning of correlations between previously collected data.

A method of predicting the occurrence of a fault in an underground pipe network by a computer, comprising the steps of: reading population prediction data for each region; and displaying data indicating one or more pipe segments, the population prediction data, and LOFs of the one or more pipe segments on a display, is also within the scope of the present disclosure. That is, when the population prediction data is displayed, the LOF of each pipe segment may be displayed instead of the LOF of each VIS unit.

It is also within the scope of this disclosure to provide a method of predicting the occurrence of a fault in an underground pipe network by a computer, the method comprising the steps of: calculating a fault likelihood of one or more pipe segments based on machine learning of correlations between previously collected data; and displaying the one or more pipe segments and the fault likelihood of the one or more pipe segments on a display. That is, based on machine learning of the correlation between data collected in the past, the future LOF of each pipe segment unit may be displayed instead of the LOF of the VIS unit.

The step of calculating an LOF for each pipe segment may include calculating an estimator of a baseline cumulative hazard function by Breslow estimation of the baseline hazard function. Calculating the LOF of each pipe segment may include calculating an estimator of a baseline survival curve with an extended Breslow estimate. This makes it possible to predict the LOF in a more distant future, and to apply the prediction to the formulation of a long-term repair plan.

The pipe failure prediction method of the present disclosure may further include steps performed by the pipe failure prediction device 100.

FIG. 22 is a diagram showing an example of a hardware configuration of a device for executing the pipe failure prediction method according to the present disclosure. The device 200 of FIG. 22 includes one or more processors 210 and one or more memories 220 in communication with the one or more processors. The one or more memories include computer-executable instructions, and when the instructions are executed by the one or more processors, the instructions cause the one or more processors to execute the pipe failure prediction method according to the present disclosure.

The one or more processors 210 and the one or more memories 220 may be included in the same housing, or may be partially or entirely included in separate housings. In particular, the information may be distributed in a cloud server system. Further, the apparatus 200 may be provided with components such as a communication device, an input/output device, a display device, and a storage device as appropriate according to the application.

Furthermore, a computer program, when executed by a computer, causing the computer to execute a pipe failure prediction method according to the present disclosure is also within the scope of the present disclosure. Temporary or non-temporary computer readable storage media having such computer programs stored thereon and signals transmitting such computer programs are also within the scope of the present disclosure.

In embodiments of this disclosure, unless otherwise specified or logically conflicted, terms and/or descriptions in the different embodiments are consistent and may be mutually referenced, and technical features in different embodiments may be combined to form a new embodiment based on internal logical relationships of the different embodiments.

In addition, in this disclosure, orientation terms such as “top”, “bottom”, “left” or “right” are defined relative to an orientation in which a component is schematically placed in the accompanying drawings. It should be understood that these directional terms are relative concepts, and are used for relative description and clarification, which may vary accordingly depending on the orientation in which the components are placed in the accompanying drawings.

It may be understood that various numbers in embodiments of this disclosure are merely used for differentiation for ease of description, and are not used to limit the scope of embodiments of this disclosure. The sequence numbers of the foregoing processes do not mean execution sequences, and the execution sequences of the processes should be determined based on functions and internal logic of the processes. The terms “first”, “second”, and the like are used to distinguish between similar objects, and do not need to be used to describe a specific order or sequence.

In addition, components in the accompanying drawings in the embodiments of this disclosure are merely intended to indicate working principles of the transistor and the display device and do not truly reflect an actual size relationship of the components.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. An apparatus for predicting a failure occurring in an underground pipe network, the apparatus comprising:
a reading module configured to read connection data, wherein the connection data comprises data indicating at least one pipe segment and data indicating at least one valve, and wherein an end of each pipe segment is connected to an end of another pipe segment or a valve;
a clustering module configured to automatically create data indicating at least one cluster from the connection data, wherein each cluster comprises one or more of the at least one pipe segment which form a connection network between one or more of the at least one valve;
a cluster likelihood of failure (LOF) calculating module configured to calculate an LOF of each cluster by summing LOFs of the pipe segments included in the cluster; and
a displaying module configured to display the data indicating the at least one cluster and the LOF of each cluster on a display device.

2. The apparatus according to claim 1, wherein the reading module is further configured to read population prediction data per area, and wherein the displaying module is further configured to display the population prediction data in addition to the data indicating the at least one cluster and the LOF of each cluster.

3. The apparatus according to claim 1, further comprising an individual LOF calculating module configured to calculate an LOF of the pipe segment based on machine learning of a correlation between data collected before.

4. The apparatus according to claim 3, wherein the individual LOF calculating module is configured to calculate the LOF of the pipe segment using an estimated cumulative hazard function Ĥ₀(t) in terms of a Breslow estimator ĥ₀(tⱼ) of a baseline hazard function as
$${\hat{H}}_{0} ( t ) = {\sum }_{j : {t}_{j} \leq t} {\hat{h}}_{0} ( {t}_{j} )$$
$${\hat{h}}_{0} ( {t}_{j} ) = \frac{{δ}_{j}}{{\sum }_{k ∈ ℛ ( {t}_{j} )} {e}^{{\hat{β}}^{T} {X}_{k}}}$$
for time t (t0<t=t1 with constants t0 and t1) and a set of features X, wherein \hat{β} represents regression coefficients obtained by machine learning, δⱼ represents a total number of events at time j, and [symbol] (tⱼ) represents a set of individuals still at risk at time j.

5. The apparatus according to claim 3, wherein the individual LOF calculating module is configured to calculate the LOF of the pipe segment using an estimation of a baseline survival curve exp (−H₀(t) for time t (t1<t<t2 with constants t1 and t2) by an extended Breslow estimator
$${\hat{S}}_{0} ( t ) = X \hat{β}$$
wherein \hat{β} represents regression coefficients calculated by a least squares method within a range of t0<t<t1 with a constant t0.

6. A method for predicting a failure occurring in an underground pipe network by a computer, the method comprising:
reading connection data, wherein the connection data comprises data indicating at least one pipe segment and data indicating at least one valve, and wherein an end of each pipe segment is connected to an end of another pipe segment or a valve;
automatically creating data indicating at least one cluster from the connection data, wherein each cluster comprises one or more of the at least one pipe segment which form a connection network between one or more of the at least one valve;
calculating a cluster likelihood of failure (LOF) of each cluster by summing LOFs of the pipe segments included in the cluster; and
displaying, on a display device, the at least one cluster and the LOF of each cluster.

7. The method according to claim 6, further comprising:
reading population prediction data per area; and
displaying, on the display device, the population prediction data in addition to the data indicating the at least one cluster and the LOF of each cluster.

8. The method according to claim 6, comprising:
calculating an LOF of the pipe segment based on machine learning of a correlation between data collected before.

9. A method for predicting a failure occurring in an underground pipe network by a computer, the method comprising:
reading population prediction data per area; and
displaying, on a display device, data indicating at least one pipe segment, the population prediction data, and a likelihood of failure (LOF) of the at least one pipe segment.

10. A method for predicting a failure occurring in an underground pipe network by a computer, the method comprising:
calculating a likelihood of failure (LOF) of at least one pipe segment based on machine learning of a correlation between data collected before; and
displaying, on a display device, data indicating the at least one pipe segment, and the LOF of the at least one pipe segment.

11. The method according to claim 10, wherein the calculating LOF of at least one pipe segment comprises calculating an estimated cumulative hazard function Ĥ₀(t) in terms of a Breslow estimator ĥ₀(tⱼ) of a baseline hazard function as
$${\hat{H}}_{0} ( t ) = {\sum }_{j : {t}_{j} \leq t} {\hat{h}}_{0} ( {t}_{j} )$$
$${\hat{h}}_{0} ( {t}_{j} ) = \frac{{δ}_{j}}{{\sum }_{k ∈ ℛ ( {t}_{j} )} {e}^{{\hat{β}}^{T} {X}_{k}}}$$
for time t (t0<t<t1 with constants t0 and t1) and a set of features X, wherein \hat{β} represents regression coefficients obtained by machine learning, δⱼ represents a total number of events at time j, and [symbol] (tⱼ) represents a set of individuals still at risk at time j.

12. The method according to claim 10, wherein the calculating LOF of at least one pipe segment comprises calculating an estimation of a baseline survival curve exp(−H₀(t) for time t (t1<t<t2 with constants t1 and t2) by an extended Breslow estimator
$${\hat{S}}_{0} ( t ) = X \hat{β}$$
wherein \hat{β} represents regression coefficients calculated by a least squares method within a range of t0<t<t1 with a constant t0.

13. An apparatus comprising:
at least one processor; and
at least one memory communicating with the at least one processor, the at least one memory comprising computer-executable instructions,
wherein when the instructions are executed by the at least one processor, the instructions cause the at least one processor to execute the method according to claim 6.

14. A non-transitory computer-readable storage medium comprising a computer program, wherein when the program is executed on a computer, the program causes the computer to execute the method according to claim 6.

15. An apparatus comprising:
at least one processor; and
at least one memory communicating with the at least one processor, the at least one memory comprising computer-executable instructions,
wherein when the instructions are executed by the at least one processor, the instructions cause the at least one processor to execute the method according to claim 9.

16. A non-transitory computer-readable storage medium comprising a computer program, wherein when the program is executed on a computer, the program causes the computer to execute the method according to claim 9.

17. An apparatus comprising:
at least one processor; and
at least one memory communicating with the at least one processor, the at least one memory comprising computer-executable instructions,
wherein when the instructions are executed by the at least one processor, the instructions cause the at least one processor to execute the method according to claim 10.

18. A non-transitory computer-readable storage medium comprising a computer program, wherein when the program is executed on a computer, the program causes the computer to execute the method according to claim 10.
